(19) United States
(12) Patent Application Publication
(10) Pub. No.: US 2014/0142931 A1
(43) Pub. Date: May 22, 2014

(54) PITCH DETECTION METHOD AND APPARATUS

(71) Applicant: Huawei Technologies Co., Ltd., Shenzhen (CN)

(72) Inventors: Fengyan Qi, Shenzhen (CN); Lei Miao, Beijing (CN); Anisse Taleb, Stockholm (SE)

(73) Assignee: Huawei Technologies Co., Ltd., Shenzhen (CN)

(21) Appl. No.: 14/136,130

(22) Filed: Dec. 20, 2013

Related U.S. Application Data
(63) Continuation of application No. PCT/CN2012/077456, filed on Jun. 25, 2012.

(30) Foreign Application Priority Data
Jun. 22, 2011 (CN) 201110170075.0

(51) Int. Cl. G10L 19/02

(52) U.S. Cl. CPC G10L 19/02
USPC 704/207

(57) ABSTRACT

The present invention discloses a pitch detection method and apparatus, which belong to the field of speech and audio. The pitch detection method includes: performing pitch detection on a speech signal in a time domain to obtain an initial pitch period; converting the speech signal to a frequency domain to obtain a frequency spectrum of the speech signal, where the frequency spectrum includes a magnitude spectrum of the frequency spectrum; extracting a feature parameter according to the initial pitch period and the frequency spectrum of the speech signal; and performing fine pitch period detection according to the initial pitch period and the feature parameter to obtain a fine pitch period.

### CROSS-REFERENCE TO RELATED APPLICATION

This application is a continuation of International Application No. PCT/CN2012/077456, filed on Jun. 25, 2012, which claims priority to Chinese Patent Application No. 201110170075.0, filed on Jun. 22, 2011, both of which are hereby incorporated by reference in their entireties.

### TECHNICAL FIELD

The present invention relates to a pitch detection method and apparatus, and in particular, to a pitch detection method and apparatus with high precision and low operational complexity.

### BACKGROUND

In the field of digital communications, transmission of speech, images, audio and video is widely demanded in applications such as mobile phone calls, audio/video conferences, broadcast and television, and multimedia entertainment. To reduce resources occupied for storing or transmitting audio/video signals, audio/video compression encoding technologies have emerged. During the processing of speech and audio signals, pitch detection is one of key technologies in various practical speech and audio applications, a pitch is an important extraction parameter in speech encoding, speech recognition and tone retrieval, and the accuracy of pitch detection directly affects the performance of eventual encoding. In the prior art, two methods are usually adopted for pitch period detection.

One method is a time domain method, after a speech signal is pre-processed, an input signal is analyzed and calculated in a time domain to determine a pitch period.

For a speech signal, a relevant function method is mostly adopted to perform pitch detection on the speech signal in the time domain, and detection is performed on relevant values of the speech signal only in the time domain. However, relevant values of a speech signal in an integral multiple of an actual pitch period are all very large, which are very difficult to be accurately distinguished and detected, and a multiple pitch error occurs easily, thereby reducing the precision of pitch parameter detection.

The other method is a frequency domain method, which is to convert a time domain signal to a frequency domain, and perform peak detection in the frequency domain, obtain a pitch frequency according to a detected peak and a pitch tracking algorithm, perform corresponding conversion on the pitch frequency and obtain the pitch period.

In this process, the conversion of a time domain signal to the frequency domain and a pitch search in the frequency domain have high operational complexity, and are thus difficult to be adopted in practical applications.

### SUMMARY

Embodiments of the present invention provide a pitch detection method and apparatus with high precision and low operational complexity.

To achieve the above objectives, the embodiments of the present invention adopt the following technical solutions.

A pitch detection method includes:

performing pitch detection on a speech signal in a time domain to obtain an initial pitch period;

converting the speech signal to a frequency domain to obtain a frequency spectrum of the speech signal, where the frequency spectrum includes a magnitude spectrum of the frequency spectrum;

extracting a feature parameter according to the initial pitch period and the frequency spectrum of the speech signal; and

performing fine pitch period detection according to the initial pitch period and the feature parameter to obtain a fine pitch period.

A pitch detection apparatus includes:

an initial pitch period obtaining module, configured to perform pitch detection on a speech signal in a time domain to obtain an initial pitch period;

a time frequency conversion module, configured to convert the speech signal to a frequency domain to obtain a frequency spectrum of the speech signal, where the frequency spectrum includes a magnitude spectrum of the frequency spectrum;

a feature parameter extraction module, configured to extract a feature parameter according to the initial pitch period and the frequency spectrum of the speech signal; and

a fine pitch period obtaining module, configured to perform fine pitch period detection according to the initial pitch period and the feature parameter to obtain a fine pitch period.

For the pitch detection method and apparatus provided in the embodiments of the present invention, by performing detection on a pitch period according to an initial pitch period obtained in a time domain and a feature parameter extracted in a frequency domain, the occurrence of a multiple pitch error is avoided and the precision of pitch period detection is improved.

### BRIEF DESCRIPTION OF DRAWINGS

FIG. 1 is a flow chart of a pitch detection method according to an embodiment of the present invention;

FIG. 2 is a schematic structural diagram of windowing of speech information in a pitch detection method according to an embodiment of the present invention;

FIG. 3 is a flow chart of time frequency conversion in a pitch detection method according to an embodiment of the present invention;

FIG. 4 is a flow chart of performing multiple pitch frequency detection on a triple pitch frequency according to a ratio parameter value of frequency point average magnitude and frequency point magnitude and an average magnitude parameter value in a pitch detection method according to an embodiment of the present invention;

FIG. 5 is a flow chart of performing multiple pitch frequency detection on a double pitch frequency according to a ratio parameter value of a frequency point average magnitude and frequency point magnitude and an average magnitude parameter value in a pitch detection method according to an embodiment of the present invention;

FIG. 6 is a flow chart of performing multiple pitch frequency detection on a triple pitch frequency according to a ratio parameter value of a frequency point average magnitude and frequency point magnitude and cache data in a pitch detection method according to an embodiment of the present invention;

FIG. 7 is a flow chart of performing multiple pitch frequency detection on a double pitch frequency according to a ratio parameter value of a frequency point average magnitude and frequency point magnitude and cache data in a pitch detection method according to an embodiment of the present invention;

FIG. 8 is a flow chart of performing interpolation on a magnitude spectrum in a pitch detection method according to an embodiment of the present invention;

FIG. 9 is a flow chart of performing zero padding on a speech signal in a pitch detection method according to an embodiment of the present invention;

FIG. 10 is a flow chart of detecting a full frequency domain in a pitch detection method according to an embodiment of the present invention;

FIG. 11 is a schematic structural diagram of a pitch detection apparatus according to an embodiment of the present invention;

FIG. 12 is a schematic structural diagram of a time frequency conversion module in a pitch detection apparatus according to Embodiment 2 of the present invention; and

FIG. 13 is a schematic structural diagram of a time frequency conversion module in a pitch detection apparatus according to Embodiment 3 of the present invention.

### DESCRIPTION OF EMBODIMENTS

In the field of digital signal processing, an audio codec and a video codec are widely applied to various electronic devices, such as a mobile phone, a radio device, a personal data assistant (PDA), a handheld or portable computer, a GPS receiver/navigator, a camera, an audio/video player, a video camera, a video recorder and a monitoring device. Generally, this type of electronic device includes an audio encoder or an audio decoder, and the audio encoder or decoder may be implemented directly by a digital circuit or a chip such as a DSP (digital signal processor), or implemented by a software code driving a processor to execute a procedure in the software code. Generally, there is a pitch detection procedure in the audio encoder. A pitch detection method according to an embodiment of the present invention is described in detail in the following with reference to the accompanying drawings.

### Embodiment 1

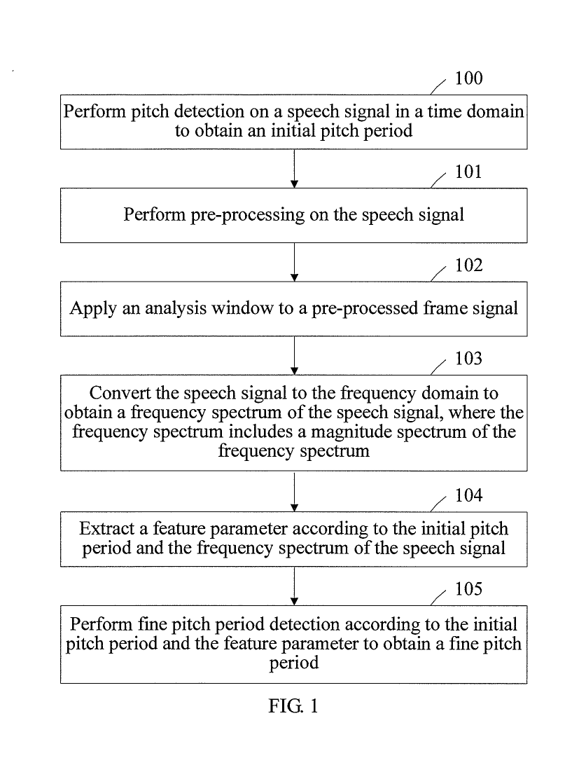

A pitch detection method, as shown in FIG. 1, includes:

Step 100: Perform pitch detection on a speech signal in a time domain to obtain an initial pitch period.

In the time domain, open-loop pitch detection may be performed according to a speech signal that has undergone perceptual weighting, to obtain an initial pitch period T′.

Step 101: Perform pre-processing on the speech signal.

Pre-processing is performed on a speech signal s(n), for example, pre-emphasis processing is performed, so as to emphasize a high-frequency component in the speech signal and improve the precision of speech encoding. After the pre-processing for the speech signal is completed, a pre-processed speech signal sₚᵣₑ(n) is obtained. To convert the speech signal to a frequency domain and make the pitch detection more precise, early stage processing needs to be performed on the speech signal.

Step 102: Apply an analysis window to a pre-processed frame signal.

According to the speech signal sₚᵣₑ(n) that has been pre-processed, the analysis window is applied to the pre-processed frame signal, and the function of the analysis window is:

$${w}_{FFT} ( n ) = \sqrt{0.5 - 0.5 cos ( \frac{2 π n}{{L}_{FFT}} )} = sin ( \frac{π n}{{L}_{FFT}} ) , \\ n = 0 , 1 , 2 , … , {L}_{FFT} - 1 ,$$

where L_{FFT} is the length of the analysis window.

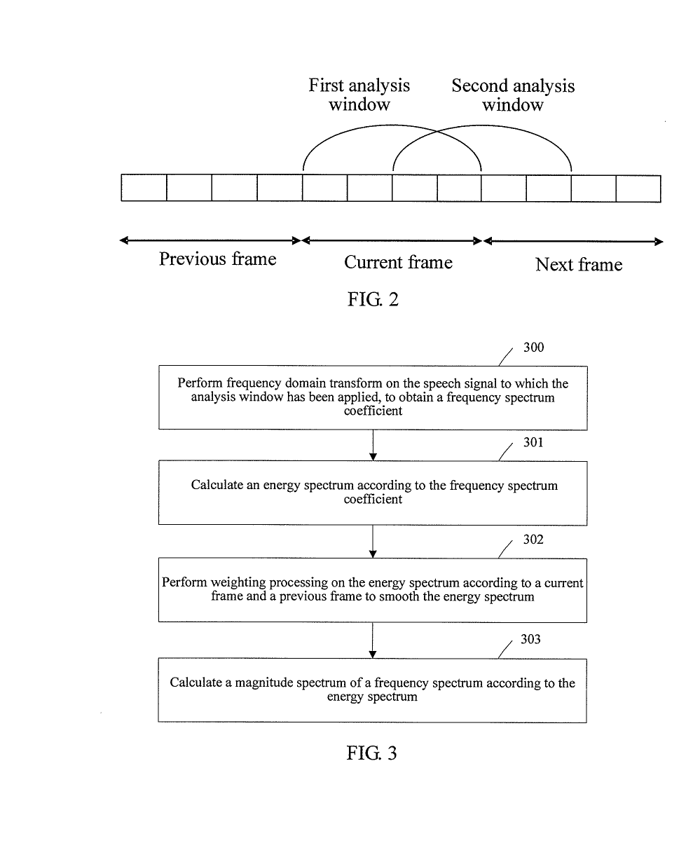

A first analysis window is applied to a current frame, and a second analysis window is applied to the second half frame of the current frame and the first half frame of a next frame, as shown in FIG. 2.

The function of the first analysis window is: s^{[0]}_{wnd}(n)=w_{FFT}(n)sₚᵣₑ(n), n=0, 1, 2, . . . , L_{FFT}−1.

The function of the second analysis window is: s^{[1]}_{wnd}(n)w_{FFT}(n)sₚᵣₑ(n+L_{FFT}/2), n=0, 1, 2, . . . , L_{FFT}−1.

Step 103: Convert the speech signal to the frequency domain to obtain a frequency spectrum of the speech signal, where the frequency spectrum includes a magnitude spectrum of the frequency spectrum.

To perform detection the speech signal in the frequency domain, the frequency spectrum of the speech signal in the frequency domain needs to be obtained, and the frequency spectrum includes the magnitude spectrum of the frequency spectrum. As shown in FIG. 3, an embodiment of this step includes the following.

Step 300: Perform frequency domain transform on the speech signal to which the analysis window has been applied, to obtain a frequency spectrum coefficient.

To obtain the frequency spectrum coefficient, Fourier transform is performed on the speech signal to which the window has been applied, for example, a frame length L_{FFT} is 256. In an actual application, Fourier transform of 256 points may be performed to obtain a corresponding frequency spectrum coefficient, and a function of the frequency spectrum coefficient is:

$$X ( k ) = {\sum }_{n = 0}^{N - 1} {s}_{wnd} ( n ) {e}^{- j 2 π \frac{kn}{N}} , \\ k = 0 , 1 , 2 , … , K - 1 , \\ K \leq {L}_{FFT} / 2 , \\ N = {L}_{FFT} ,$$

where the frequency spectrum coefficient is a complex number and includes a real part and an imaginary part.

Step 301: Calculate an energy spectrum according to the frequency spectrum coefficient.

Calculate the sum of the squares of the real part and the imaginary part in the frequency spectrum coefficient to calculate the energy spectrum, and a function E(k) of the energy spectrum is:
E(k)=X_{R}²(k)+X_{I}²(k), k=0, 1, 2, . . . , K−1, where X_{R}(k) and X_{I}(k) denote the real part and the imaginary part respectively.

Step 302: Perform weighting processing on the energy spectrum according to the current frame and a previous frame to smooth the energy spectrum.

To further improve the precision of a pitch period detection, the energy spectrum may be weighted according to the current frame and the previous frame to obtain a smooth energy spectrum, and a function of the smooth energy spectrum is:
\tilde{E}(k)=αE^{[0]}(k)+(1−α)E^{[1]}(k), k=0, 1, 2, . . . , K−1, 0<α≦1, where E^{[0]}(k) is a energy spectrum generated according to the first analysis window, E^{[1]}(k) is a energy spectrum generated according to the second analysis window, and the value of α represents proportions which E^{[0]}(k) and E^{[1]}(k) account for in \tilde{E}(k), which is selected according to experience, for example, may be set to 0.5.

Step 303: Calculate the magnitude spectrum of the frequency spectrum according to the energy spectrum.

A root-extraction operation is performed on the function of the energy spectrum to obtain a function of the magnitude spectrum. In a process of calculating the function of the magnitude spectrum, to prevent the value of the function of the magnitude spectrum from being excessively large, a logarithm operation is performed on the function of the magnitude spectrum and a magnitude range is compressed. When the value of the function of the smooth energy spectrum is 0, its logarithm value approaches negative infinity, and an overflowing phenomenon may occur during the operation, so a smaller positive number ε is set to prevent the overflowing of the logarithm value. The function of the magnitude spectrum is:
S(k)=+η+θ log₁₀(\sqrt{ε+\tilde{E}(k)}), k=0, 1, 2, . . . , K−1, where θ and η are constants, the magnitude range of the frequency spectrum may be adjusted by setting the constants, for example, the constants may be set to θ=2 η=log₁₀(4/L²_{FFT}).

Step 104: Extract a feature parameter according to the initial pitch period and the frequency spectrum of the speech signal.

A reciprocal operation is performed on the initial pitch period T′ to obtain a fundamental frequency ƒ′. A multiplication operation is performed on the fundamental frequency ƒ′ to obtain a multiple pitch frequency, for example, 2ƒ′ and ƒ′/2.

The feature parameter includes: an average magnitude parameter, a ratio parameter of an average magnitude and a frequency point magnitude, and a peak position parameter.

To perform detection on a fine pitch period to avoid the occurrence of a multiple pitch error, a function needs to be set to obtain a magnitude and a fluctuation characteristic of the magnitude spectrum to determine the fine pitch period, for example, the function is set to:

$$\breve{S} ( k ) = \frac{{\sum }_{i = - {f}^{′} + 1}^{{f}^{′} - 1} S ( i + k )}{2 {f}^{′} - 1} , \\ k = {f}^{′} / 3 , {f}^{′} / 2 , {f}^{′} , 2 {f}^{′} , 3 {f}^{′}$$

$$r ( k ) = \frac{\breve{S} ( k )}{S ( k )} , \\ k = {f}^{′} / 3 , {f}^{′} / 2 , {f}^{′} , 2 {f}^{′} , 3 {f}^{′} ,$$

where \check{S}(k) is a function of the average magnitude, S(k) is the function of the magnitude spectrum, and ƒ′ is a corresponding frequency point of the initial pitch period T′ in the frequency domain; during the detection, the value of \check{S}(k) represents an average magnitude of a frequency point that is in the range of 2ƒ′−1 and centered on a frequency point k to be measured. r(k) is a ratio function of an average magnitude and a magnitude of the frequency point to be measured.

During the detection, values of the fundamental frequency, a double pitch frequency and a triple pitch frequency are substituted in the function to obtain fundamental frequency feature parameters \check{S}(ƒ′) and r(ƒ′), double pitch frequency feature parameters \check{S}(2ƒ′) and r(2ƒ′), and triple pitch frequency feature parameters \check{S}(3ƒ′) and r(3ƒ′).

Step 105: Perform fine pitch period detection according to the initial pitch period and the feature parameter to obtain a fine pitch period.

Multiple pitch frequency detection is performed on the speech signal according to the initial pitch period and the feature parameter. In actual detection, most multiple pitch errors occur at positions of a fundamental frequency point, a double pitch frequency point and a triple pitch frequency point in the frequency domain, so when required precision of detection is not high, to reduce the complexity of the detection, the detection may only be performed on the fundamental frequency, the double pitch frequency and the triple pitch frequency.

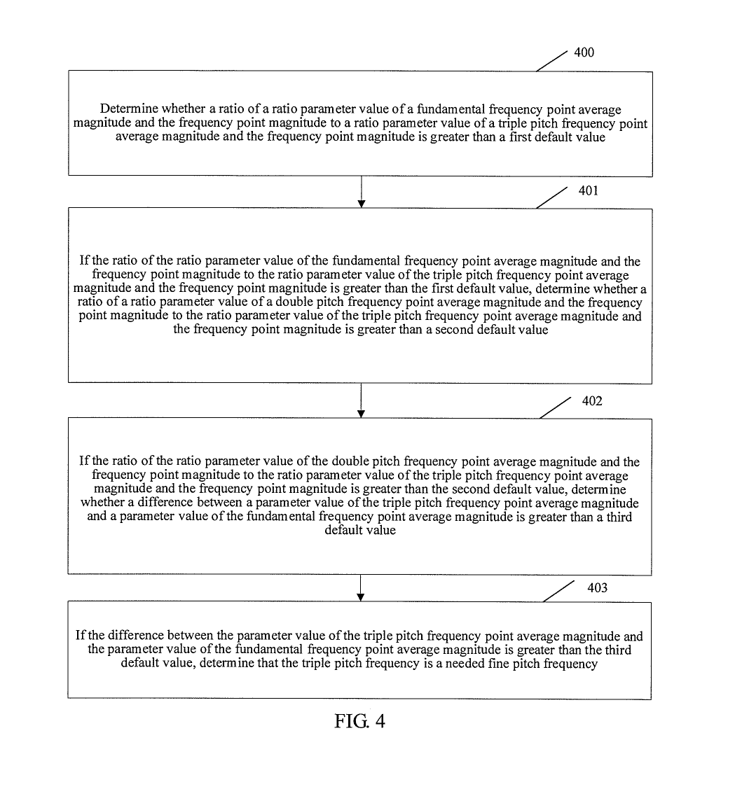

When the detection is performed on the triple pitch frequency according to a ratio parameter value of a frequency point average magnitude and frequency point magnitude and an average magnitude parameter value, as shown in FIG. 4, the following is included.

Step 400: Determine whether a ratio of a ratio parameter value of a fundamental frequency point average magnitude and the frequency point magnitude to a ratio parameter value of a triple pitch frequency point average magnitude and the frequency point magnitude is greater than a first default value.

It can be known according to an average magnitude parameter \check{S}(k) and a ratio parameter r(k) of an average magnitude and a frequency point magnitude that, the larger a magnitude value of a detected frequency point is relative to the average magnitude parameter (k) the smaller the value of r(k) is, which indicates that a peak occurs at this frequency point, and the fluctuation characteristic of the magnitude spectrum is obvious.

During the detection, at the position of a real pitch frequency, the peak occurs. At this time, a magnitude value S(k) at this frequency point is greater than the value of the average magnitude parameter \check{S}(k) in the range 2ƒ′−1 around the frequency point, so the value r(k) of the ratio parameter of the average magnitude and frequency point magnitude is small. Therefore, according to \check{S}(k) and r(k) of the fundamental frequency point, the double pitch frequency point and the triple pitch frequency point, it may be determined whether a multiple pitch error occurs in the obtained pitch period.

During the multiple pitch frequency detection, it is first determined whether the position of 3ƒ′ may be at a fine pitch frequency. To make the multiple pitch frequency detection more accurate, a first default value δ₁ is set, and only when a ratio of r(ƒ′) to r(3ƒ′) is greater than δ₁, the position of 3ƒ′ may be at the fine pitch frequency and the first default value δ₁ may be set to 1.22 according to experience.

Step 401: If the ratio of the ratio parameter value of the fundamental frequency point average magnitude and the frequency point magnitude to the ratio parameter value of the triple pitch frequency point average magnitude and the frequency point magnitude is greater than the first default value, determine whether a ratio of a ratio parameter value of a double pitch frequency point average magnitude and the frequency point magnitude to the ratio parameter value of the triple pitch frequency point average magnitude and the frequency point magnitude is greater than a second default value.

When the ratio of r(ƒ′) to r(3ƒ′) is greater than the first default value δ₁, it is determined whether a ratio of r(2ƒ′) to r(3ƒ′) is greater than the second default value λ₁, and the second default value λ₁ may be set to 1.22 according to experience.

Step 402: If the ratio of the ratio parameter value of the double pitch frequency point average magnitude and the frequency point magnitude to the ratio parameter value of the triple pitch frequency point average magnitude and the frequency point magnitude is greater than the second default value, determine whether a difference between a parameter value of the triple pitch frequency point average magnitude and a parameter value of the fundamental frequency point average magnitude is greater than a third default value.

When the ratio of r(2ƒ′) to r(3ƒ′) is greater than the second default value λ₁, it is determined whether a difference between \check{S}(3ƒ′) and \check{S}(ƒ′) is greater than a third default value γ₁, and the third default value γ₁ may be set to 0.6 according to experience.

Step 403: If the difference between the parameter value of the triple pitch frequency point average magnitude and the parameter value of the fundamental frequency point average magnitude is greater than the third default value, determine that the triple pitch frequency is a needed fine pitch frequency.

When the above three conditions are satisfied at the same time, it may be determined that among the fundamental frequency, the double pitch frequency and the triple pitch frequency, the triple pitch frequency is a fine pitch frequency, and the needed fine pitch period may be determined according to the fine pitch frequency.

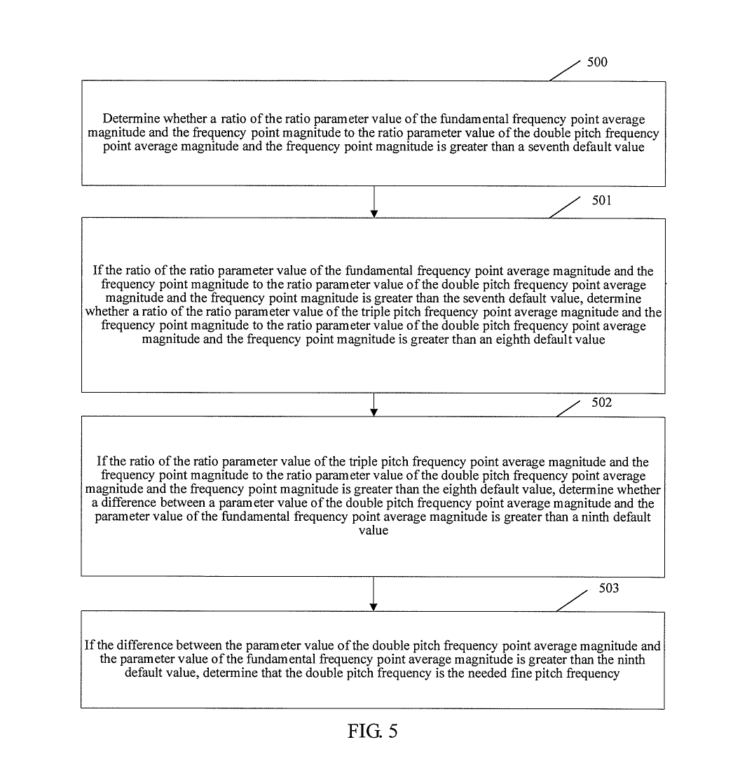

If the triple pitch frequency is not the needed fine pitch frequency, detection is performed on the double pitch frequency according to the ratio parameter value of the frequency point average magnitude and frequency point magnitude and the average magnitude parameter value. As shown in FIG. 5, the following is included.

Step 500: Determine whether a ratio of the ratio parameter value of the fundamental frequency point average magnitude and the frequency point magnitude to the ratio parameter value of the double pitch frequency point average magnitude and the frequency point magnitude is greater than a seventh default value.

Similar to the detection of the triple pitch error, it is determined whether a ratio of r(ƒ′) to r(2ƒ′) is greater than δ₂, and the seventh default value δ₂ may be set to 1.22 according to experience.

Step 501: If the ratio of the ratio parameter value of the fundamental frequency point average magnitude and the frequency point magnitude to the ratio parameter value of the double pitch frequency point average magnitude and the frequency point magnitude is greater than the seventh default value, determine whether a ratio of the ratio parameter value of the triple pitch frequency point average magnitude and the frequency point magnitude to the ratio parameter value of the double pitch frequency point average magnitude and the frequency point magnitude is greater than an eighth default value.

When the ratio of r(ƒ′) to r(2ƒ′) is greater than the seventh default value δ₂, it is determined whether a ratio of r(3ƒ′) to r(2ƒ′) is greater than the eighth default value λ₂, and the eighth default value λ₂ may be set to 1.22 according to experience.

Step 502: If the ratio of the ratio parameter value of the triple pitch frequency point average magnitude and the frequency point magnitude to the ratio parameter value of the double pitch frequency point average magnitude and the frequency point magnitude is greater than the eighth default value, determine whether a difference between a parameter value of the double pitch frequency point average magnitude and the parameter value of the fundamental frequency point average magnitude is greater than a ninth default value.

When the ratio of r(3ƒ′) to r(2ƒ′) is greater than the eighth default value λ₂, it is further determined whether a difference between \check{S}(2ƒ′) and \check{S}(ƒ′) is greater than the ninth default value γ₂, and the ninth default value γ₂ may be set to 0.4 according to experience.

Step 503: If the difference between the parameter value of the double pitch frequency point average magnitude and the parameter value of the fundamental frequency point average magnitude is greater than the ninth default value, determine that the double pitch frequency is the needed fine pitch frequency.

When the above three conditions are satisfied at the same time, it may be determined that in the fundamental frequency, the double pitch frequency and the triple pitch frequency, the double pitch frequency is a fine pitch frequency, and the needed fine pitch period may be determined according to the fine pitch frequency.

### Embodiment 2

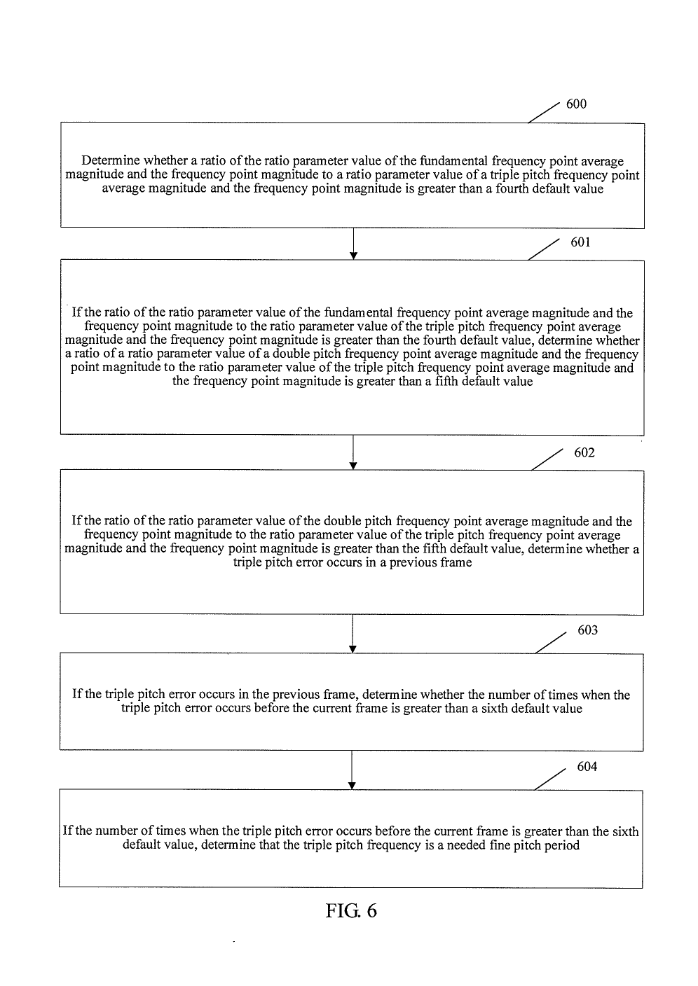

During multiple pitch frequency detection, further determination may be performed according to a ratio parameter value of a frequency point average magnitude and frequency point magnitude and a determination result of a multiple pitch frequency before a current frame stored in a cache. As shown in FIG. 6, detection of a triple pitch frequency includes the following.

Step 600: Determine whether a ratio of the ratio parameter value of the fundamental frequency point average magnitude and the frequency point magnitude to a ratio parameter value of a triple pitch frequency point average magnitude and the frequency point magnitude is greater than a fourth default value.

It is determined whether a ratio of r(ƒ′) to r(3ƒ′) is greater than δ₃, and the fourth default value δ₃ may be set to 1.05 according to experience.

Step 601: If the ratio of the ratio parameter value of the fundamental frequency point average magnitude and the frequency point magnitude to the ratio parameter value of the triple pitch frequency point average magnitude and the frequency point magnitude is greater than the fourth default value, determine whether a ratio of a ratio parameter value of a double pitch frequency point average magnitude and the frequency point magnitude to the ratio parameter value of the triple pitch frequency point average magnitude and the frequency point magnitude is greater than a fifth default value.

When the ratio of r(ƒ′) to r(3ƒ′) is greater than the fourth default value δ₃, it is determined whether a ratio of r(2ƒ′) to r(3ƒ′) is greater than a fifth default value λ₃, and the fifth default value λ₃ may be set to 1.05 according to experience.

Step 602: If the ratio of the ratio parameter value of the double pitch frequency point average magnitude and the frequency point magnitude to the ratio parameter value of the triple pitch frequency point average magnitude and the frequency point magnitude is greater than the fifth default value, determine whether a triple pitch error occurs in a previous frame.

When the ratio of the ratio parameter value of the double pitch frequency point average magnitude and the frequency point magnitude to the ratio parameter value of the triple pitch frequency point average magnitude and the frequency point magnitude is greater than the fifth default value λ₃, according to a mark of the previous frame stored in the cache, it is determined whether a triple pitch error has already occurred in the previous frame.

Step 603: If the triple pitch error occurs in the previous frame, determine whether the number of times when the triple pitch error occurs before the current frame is greater than a sixth default value.

When it is determined that the triple pitch error has already occurred in the previous frame, it is further determined whether the number of times when the triple pitch error occurs before the current frame is greater than a sixth default value c₁. For example, it is determined whether the number of times when the triple pitch error continuously occurs is greater than the sixth default value c₁ for previous 10 frames of the current frame. If the sixth default value c₁ is determined according to a whole frame, it may be set to 3, and if the sixth default value c₁ is determined according to a half frame, it may be set to 6.

Step 604: If the number of times when the triple pitch error occurs before the current frame is greater than the sixth default value, determine that the triple pitch frequency is a needed fine pitch period.

When the triple pitch error has occurred in a previous frame of a frame where a frequency point 3ƒ′ lies, and in previous 10 frames of the frame where the frequency point 3ƒ′ lies, it is recorded in the cache that the triple pitch error has occurred three times continuously, so it is determined that the triple pitch error has occurred. A real pitch frequency occurs near 3ƒ′, and 3ƒ′ is the needed fine pitch frequency.

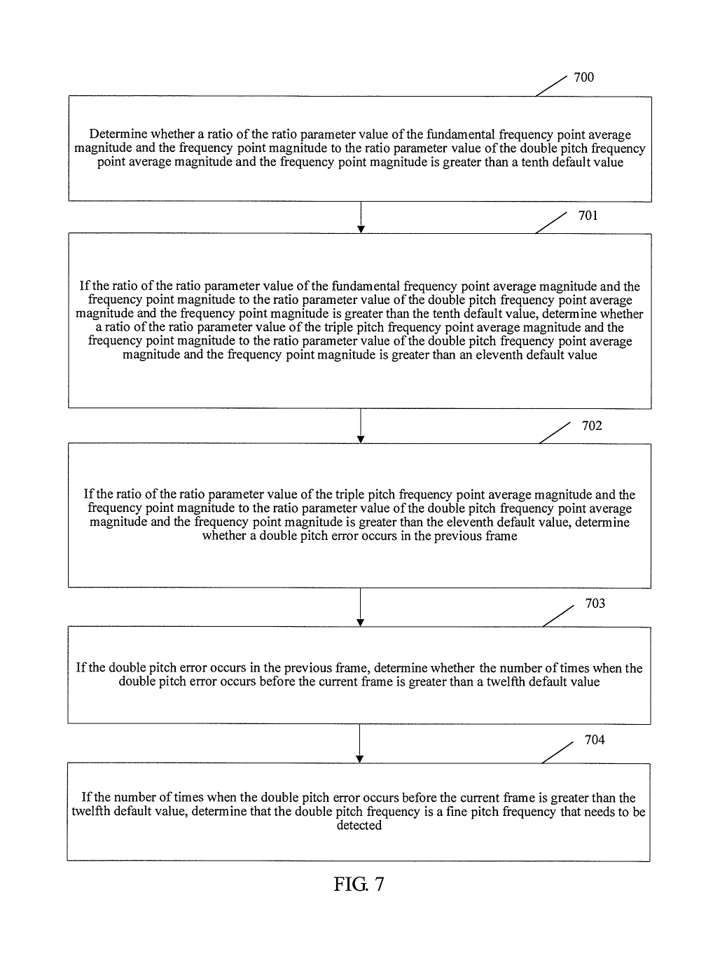

If the triple pitch frequency is not the needed fine pitch frequency, detection is performed on a double pitch frequency according to a ratio parameter value of a frequency point average magnitude and frequency point magnitude and cache data. As shown in FIG. 7, the following is included.

Step 700: Determine whether a ratio of the ratio parameter value of the fundamental frequency point average magnitude and the frequency point magnitude to the ratio parameter value of the double pitch frequency point average magnitude and the frequency point magnitude is greater than a tenth default value.

It is determined whether a ratio of r(ƒ′) to r(2ƒ′) is greater than δ₄, and the tenth default value δ₄ may be set to 1.05 according to experience.

Step 701: If the ratio of the ratio parameter value of the fundamental frequency point average magnitude and the frequency point magnitude to the ratio parameter value of the double pitch frequency point average magnitude and the frequency point magnitude is greater than the tenth default value, determine whether a ratio of the ratio parameter value of the triple pitch frequency point average magnitude and the frequency point magnitude to the ratio parameter value of the double pitch frequency point average magnitude and the frequency point magnitude is greater than an eleventh default value.

When the ratio of r(ƒ′) to r(2ƒ′) is greater than the tenth default value δ₄, it is determined whether a ratio of r(3ƒ′) to r(2ƒ′) is greater than an eleventh default value λ₄, and the eleventh default value λ₄ may be set to 1.05 according to experience.

Step 702: If the ratio of the ratio parameter value of the triple pitch frequency point average magnitude and the frequency point magnitude to the ratio parameter value of the double pitch frequency point average magnitude and the frequency point magnitude is greater than the eleventh default value, determine whether a double pitch error occurs in the previous frame.

When the ratio of the ratio parameter value of the triple pitch frequency point average magnitude and the frequency point magnitude to the ratio parameter value of the double pitch frequency point average magnitude and the frequency point magnitude is greater than the eleventh default value λ₄, according to the mark of the previous frame stored in the cache, it is determined whether the double pitch error has already occurred in the previous frame.

Step 703: If the double pitch error occurs in the previous frame, determine whether the number of times when the double pitch error occurs before the current frame is greater than a twelfth default value.

When it is determined that the triple pitch error has already occurred in the previous frame, it is further determined whether the number of times when the double pitch error occurs before the current frame is greater than the twelfth default value. For example, it is determined whether the number of times when the double pitch error continuously occurs is greater than a twelfth default value c₂ for previous 10 frames of the current frame. If the twelfth default value c₂ is determined according to a whole frame, it may be set to 3, and if the twelfth default value c₂ is determined according to a half frame, it may be set to 6.

Step 704: If the number of times when the double pitch error occurs before the current frame is greater than the twelfth default value, determine that the double pitch frequency is a fine pitch frequency that needs to be detected.

When the double pitch error occurs in a previous frame of a frame where a frequency point 2ƒ′ lies, and in previous 10 frames of the frame where the frequency point 2ƒ′ lies, it is recorded in the cache that the double pitch error has occurred three times continuously, so it is determined that the double pitch error has occurred. A real pitch frequency occurs near 2ƒ′, and 2ƒ′ is the needed fine pitch frequency.

After the multiple pitch frequency detection is completed, a detection result is saved in a mark of the previous frame in the cache. For example, when it is determined that the double pitch error occurs in the current frame, it is recorded in the mark of the previous frame that the double pitch error has occurred, and the number of times when it continuously occurs is recorded, which are used for data detection for the next frame.

### Embodiment 3

During multiple pitch frequency detection on a pitch period, as described in Embodiment 1 and Embodiment 2, a fine pitch frequency may be determined in two manners: performing determination according to a ratio parameter value of a frequency point average magnitude and frequency point magnitude and an average magnitude parameter value, and performing determination according to the ratio parameter value of the frequency point average magnitude and frequency point magnitude and cache data. In practice, during the determination, determination conditions of the two determination manners are combined according to OR logic. When a determination condition of one of manners is satisfied, it may be determined that the frequency point is a needed fine pitch frequency.

For example, during determination of a triple pitch error, as long as the determination condition of performing determination according to the ratio parameter value of the frequency point average magnitude and frequency point magnitude and the average magnitude parameter value is satisfied, it may be determined that the triple pitch frequency is the needed fine pitch frequency, or as long as the determination condition of performing determination according to a ratio parameter value of average magnitude and frequency point magnitude and a determination result of a multiple pitch frequency before the current frame stored in the cache is satisfied, it may also be determined that the triple pitch frequency is the needed fine pitch frequency.

### Embodiment 4

To make multiple pitch frequency detection more precise, a high-density magnitude spectrum in a frequency domain needs to be obtained. For example, 256 frequency points exist in an original magnitude spectrum, and a high-density magnitude spectrum of the magnitude spectrum may be obtained by inserting frequency points between the frequency points.

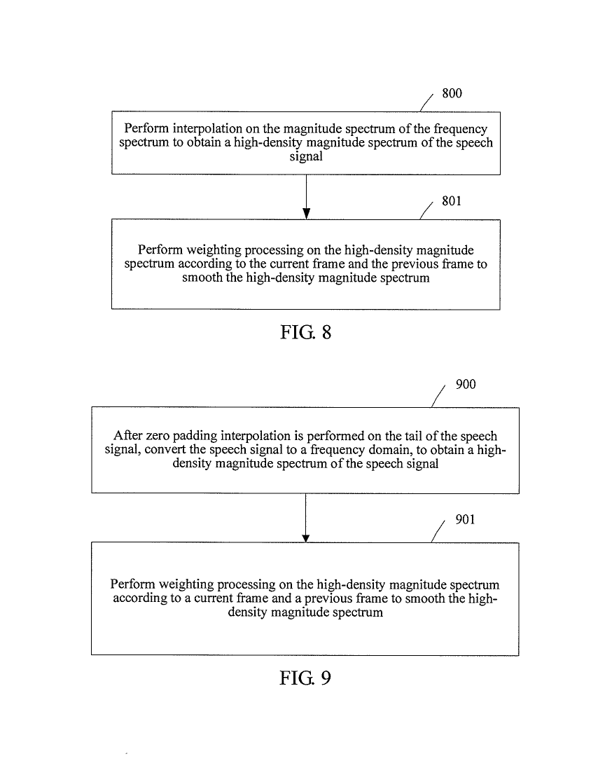

After step 303, interpolation is performed according to the obtained magnitude spectrum. As shown in FIG. 8, the step includes the following.

Step 800: Perform interpolation on the magnitude spectrum of the frequency spectrum to obtain a high-density magnitude spectrum of the speech signal.

Interpolation is performed between existing frequency points in the frequency domain according to an interpolation algorithm. In the present invention, cubic B-spline interpolation is adopted, that is, on the basis of original K frequency points, the frequency points are extended to mK frequency points, where m is a positive integer. The cubic B-spline interpolation has a certain deviation at a boundary. To reduce the error, before interpolation is performed, some pseudo-data is manually extended at two ends of data, that is, L point extension is performed on the magnitude spectrum, so that a boundary condition does not affect the precision of interpolation of actual data. Extended values are equal to values at two ends of the frequency spectrum, and the extended magnitude spectrum is:

$$\underbrace{S ( 0 ) , … , S}_{L} ( 0 ) , \\ \{ S ( k ) , k ∈ [ 0 , k - 1 ] \} , \\ \underbrace{S ( k - 1 ) ,}_{L} … , S ( k - 1 ) .$$

A function of the cubic B-spline interpolation is:

$$f ( x ) = {\sum }_{k ∈ Z}^{ } c ( k ) {β}^{3} ( x - k )$$

where, ƒ(x) denotes a magnitude of a frequency point to be inserted, the value of k is an integer, β³(x) is a cubic B-spline base function, an expression of which is:

$${β}^{3} ( x ) = \{ \begin{matrix}2 / 3 - {\vert x \vert}^{2} + {\vert x \vert}^{3} / 2 , 0 \leq \vert x \vert < 1 \\ ( 2 - {\vert x \vert}^{3} ) / 6 , 1 \leq \vert x \vert < 2 \\ 0 , \vert x \vert \geq 2.\end{matrix}$$

c(k) is a coefficient of the cubic B-spline interpolation, defined as _{c}⁻(k)=c(k)/6, and for a given K dimensional input vector y={y(0), . . . , y(K−1)}, c⁻(k) may be obtained through the following recursion equations of two formulas:
c⁺(k)=y(k)+ac⁺(k−1) k=1, 2, 3, . . . , K−1, which is equivalent to a causal filter; and
c⁻(k)=a(c⁻(k+1)−c⁺(k)) k=K−2, K−3. K−4, . . . , 0, which is equivalent to a non-causal filter,
where a=\sqrt{3}−2, and initial values c⁺(0) and c⁻(K−1) of the two recursion equations are:

$${c}^{+} ( 0 ) = {\sum }_{k = 0}^{{k}_{0}} y ( k ) {a}^{k}$$

$$and$$

$${c}^{-} ( k - 1 ) = \frac{a}{1 - {a}^{2}} ( {c}^{+} ( k - 1 ) + {ac}^{+} ( k - 2 ) ) ,$$

respectively;

where k₀>log λ/log|a|, and λ is a constant set for satisfying a precision requirement. Finally, the solved coefficient c(k) of the cubic B-spline interpolation is substituted in the formula c⁺(k)=y(k)+ac⁺(k−1) k=1, 2, 3, . . . , K−1, a sequence to be interpolated can be obtained, and the interpolated magnitude spectrum is: S′(i), i=0, 1, 2, . . . , mK−1.

Step 801: Perform weighting processing on the high-density magnitude spectrum according to the current frame and the previous frame to smooth the high-density magnitude spectrum.

After the interpolation is completed, smoothing processing is performed on the high-density magnitude spectrum to reduce discontinuity of the high-density magnitude spectrum, and a function of the smoothed high-density frequency spectrum is:
\tilde{S}(i)=βS′^{[-1]}(i)+(1−β)S′^{[0]}(i), i=0, 1, 2, . . . , mK−1, 0<β≦1, where S′^{[-1]}(i) is a high-density frequency spectrum of the previous frame, and proportions which S+^{[-]}(i) and S′^{[0]}(i) account for in \tilde{S}(i) are set through β, for example, may be set to 0.4.

\tilde{S}(i) is a needed high-density magnitude spectrum, and detection is performed on a fine pitch frequency according to the high-density magnitude spectrum.

After the smoothed high-density magnitude spectrum is obtained, detection is performed on the fine pitch period. During the detection, because the number of frequency points is increased, the precision of the average magnitude \check{S}(k) is improved and an effect caused by the jump of the frequency point magnitude value for the detection is reduced. The detection steps are the same as those in Embodiment 1 and Embodiment 2, which are repeated.

### Embodiment 5

In addition to cubic B-spline interpolation on a magnitude spectrum, zero padding interpolation may also be performed on the speech signal in a time domain. As shown in FIG. 9, the following is included.

Step 900: After zero padding interpolation is performed on the tail of the speech signal, convert the speech signal to a frequency domain, to obtain a high-density magnitude spectrum of the speech signal.

A point whose magnitude value is zero is padded at the tail of the speech signal, and the zero-padded speech signal is converted to the frequency domain. Through time frequency transform, a frequency point in an original speech signal and the point whose magnitude value is zero padded at the tail of the speech signal are converted to the frequency domain, that is, frequency points may be inserted between frequency points of the magnitude spectrum in an original frequency domain.

During the conversion from the time domain to the frequency domain, a magnitude value of an original frequency point in the magnitude spectrum is not affected by a zero-padding point, that is, in the magnitude spectrum, the original frequency point and the magnitude value corresponding to the frequency point are maintained, thereby obtaining the high-density magnitude spectrum corresponding to the time domain signal in the frequency domain.

Step 901: Perform weighting processing on the high-density magnitude spectrum according to a current frame and a previous frame to smooth the high-density magnitude spectrum.

After the time frequency transform is completed to obtain the needed high-density magnitude spectrum, to reduce the jumps of the high-density magnitude spectrum, smoothing processing is performed thereon, and a function of the smoothed high-density magnitude spectrum is:
\tilde{S}(i)=βS′^{[-1]}(i)+(1−β)S′^{[0]}(i), i=0, . . . , mK−1, 0<β≦1, where S′^{[-1]}(i) is a high-density magnitude spectrum of the previous frame, and proportions which S′^{[-1]}(i) and S′^{[0]}(i) account for in \tilde{S}(i) are set through β, for example, may be set to 0.4.

\tilde{S}(i) is a needed high-density magnitude spectrum, and detection is performed on a fine pitch frequency according to the high-density magnitude spectrum.

After the smoothed high-density magnitude spectrum is obtained, detection is performed on the fine pitch period. During the detection process, because the number of frequency points is increased, the precision of an average magnitude S(k) is improved and an effect caused by the jump of the frequency point magnitude value for the detection is reduced. The detection steps are the same as those in Embodiment 1 and Embodiment 2, which are no longer repeated.

### Embodiment 6

When multiple pitch frequency detection is performed on a high-density magnitude spectrum, an obtained fine pitch frequency is a multiple of an initial pitch frequency, a search range is only at the positions of a fundamental frequency, a double pitch frequency and a triple pitch frequency, and detection is not performed on all frequency domains, which is not precise enough. To obtain a fine pitch period with higher precision, after a high-density magnitude spectrum of a speech signal is obtained, a magnitude peak search may further be performed on the high-density magnitude spectrum, and the fine pitch period may be determined according to a corresponding feature parameter.

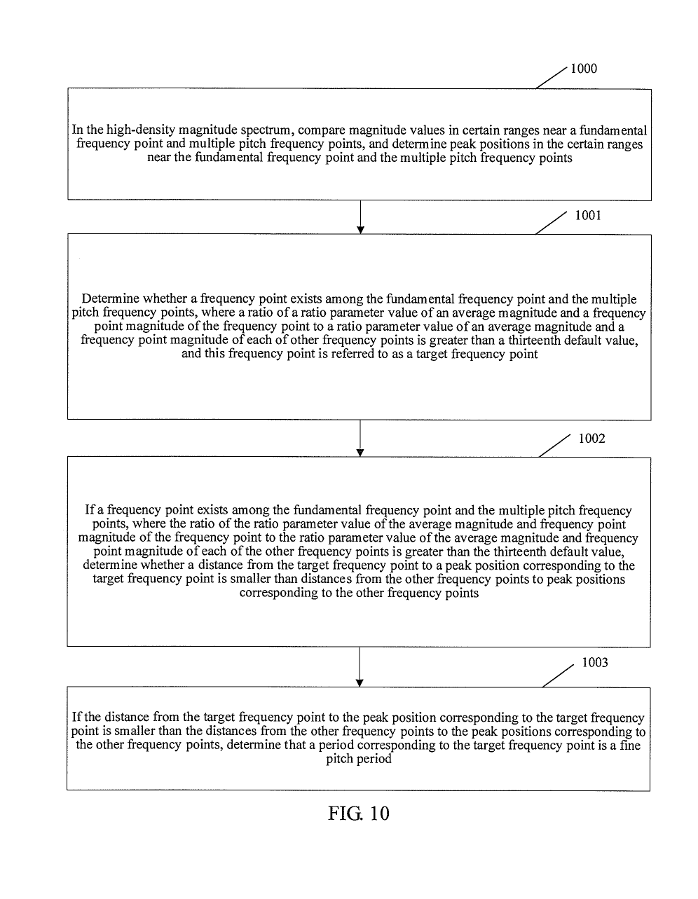

Performing detection of the fine pitch period according to the initial pitch period and the feature parameter to obtain the fine pitch period, as shown in FIG. 10, further includes the following.

Step 1000: In the high-density magnitude spectrum, compare magnitude values in certain ranges near a fundamental frequency point and multiple pitch frequency points, and determine peak positions in the certain ranges near the fundamental frequency point and the multiple pitch frequency points.

After interpolation is performed on a magnitude spectrum of a frequency spectrum, a high-density magnitude spectrum is obtained. In the high-density magnitude spectrum, in the certain ranges near the fundamental frequency point and the multiple pitch frequency points, for example, in the range of 2ƒ′−2 centered on the fundamental frequency point ƒ′, a peak search of a magnitude value is performed to determine peak positions in the certain ranges near the fundamental frequency point and the multiple pitch frequency points, where the fundamental frequency point and every multiple pitch frequency point correspond to one peak position each. In addition, peaks of magnitudes corresponding to the fundamental frequency point and the multiple pitch frequency points may be obtained.

Step 1001: Determine whether a frequency point exists among the fundamental frequency point and the multiple pitch frequency points, where a ratio of a ratio parameter value of an average magnitude and a frequency point magnitude of the frequency point to a ratio parameter value of an average magnitude and a frequency point magnitude of each of other frequency points is greater than a thirteenth default value, and this frequency point is referred to as a target frequency point.

Comparison is performed according to ratio parameter values of average magnitudes and frequency point magnitudes of the fundamental frequency point and the multiple pitch frequency points, it is determined that a ratio of a ratio parameter value of an average magnitude and a frequency point magnitude of a frequency point to a ratio parameter value of an average magnitude and a frequency point magnitude of each of all other frequency points is greater than a thirteenth default value δ, and the thirteenth default value δ may be set according to experience, for example, set to 1.22.

Step 1002: If a frequency point exists among the fundamental frequency point and the multiple pitch frequency points, where the ratio of the ratio parameter value of the average magnitude and frequency point magnitude of the frequency point to the ratio parameter value of the average magnitude and frequency point magnitude of each of the other frequency points is greater than the thirteenth default value, determine whether a distance from the target frequency point to a peak position corresponding to the target frequency point is smaller than distances from the other frequency points to peak positions corresponding to the other frequency points.

When a frequency point exists among the fundamental frequency point and the multiple pitch frequency points, where the ratio of the ratio parameter value of the average magnitude and frequency point magnitude of the frequency point to the ratio parameter value of the average magnitude and frequency point magnitude of each of other frequency points is greater than the thirteenth default value δ, it is determined whether a distance from the target frequency point to a peak position corresponding to the target frequency point is smaller than distances the other frequency points to peak positions corresponding to the other frequency points, that is, it is determined whether the distance from the target frequency point to the peak position corresponding to the target frequency point is the minimum among distances from all frequency points to peak positions corresponding to all the frequency points.

Step 1003: If the distance from the target frequency point to the peak position corresponding to the target frequency point is smaller than the distances from the other frequency points to the peak positions corresponding to the other frequency points, determine that a period corresponding to the target frequency point is a fine pitch period.

If the above two conditions are satisfied, it may be determined that the target frequency point is a needed fine pitch frequency. A reciprocal operation is performed on the fine pitch frequency to obtain a fine pitch period.

### Embodiment 7

As described in Embodiment 1, Embodiment 2 and Embodiment 6, when multiple pitch frequency detection is performed on a high-density magnitude spectrum, a determined fine pitch frequency is a fundamental frequency or a multiple pitch frequency point, and precision is relatively low. When a fine pitch period with higher precision is needed, a further search may be performed according to frequency points detected in Embodiment 1, Embodiment 2 and Embodiment 6.

The detection steps for a multiple pitch error are the same as those in Embodiment 1, Embodiment 2 and Embodiment 6, which are repeated.

After the detection is completed, a multiple pitch frequency point, for example, a triple pitch frequency point 3ƒ′ whose coefficient is an integral multiple, is determined. It is set to perform a peak search on the high-density frequency spectrum in a certain range centered on the triple pitch frequency point 3ƒ′ (for example, 2ƒ′−2 between a double pitch frequency point 2ƒ′ and a quadruple pitch frequency point 4ƒ′). When a coefficient of the determined multiple pitch frequency point is a half pitch frequency point ƒ′/2 of a fractional multiple, it may be set that a peak search range is a range of 2k−2 (k is a frequency of a frequency point to be searched for) centered on ƒ′/2, and finally it may be determined that the peak position is the fine pitch frequency. A reciprocal operation is performed on the fine pitch frequency, and a needed fine pitch period may be determined.

A frequency point corresponding to an obtained peak in the range is the needed fine pitch frequency.

Corresponding to the above pitch detection method, the present invention further provides a pitch detection apparatus.

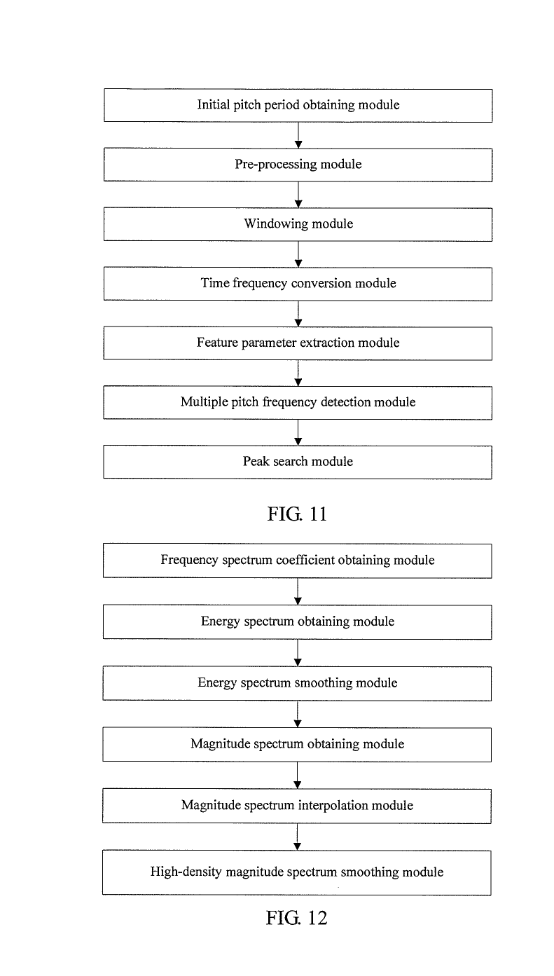

A pitch detection apparatus, as shown in FIG. 11, includes:

an initial pitch period obtaining module, configured to perform pitch detection on a speech signal in a time domain to obtain an initial pitch period;

a time frequency conversion module, configured to convert the speech signal to a frequency domain to obtain a frequency spectrum of the speech signal, where the frequency spectrum includes a magnitude spectrum of the frequency spectrum;

a feature parameter extraction module, configured to extract a feature parameter according to the initial pitch period and the frequency spectrum of the speech signal; and

a fine pitch period obtaining module, configured to perform fine pitch period detection according to the initial pitch period and the feature parameter to obtain a fine pitch period.

The feature parameter includes: an average magnitude parameter, a ratio parameter of an average magnitude and a frequency point magnitude, and a peak position parameter.

The fine pitch period obtaining module further includes:

a multiple pitch frequency detection module, configured to compare feature parameters of a fundamental frequency point and a multiple pitch frequency point, and determine a fine pitch frequency.

The multiple pitch frequency detection module further includes:

a peak search module, configured to search for a magnitude peak in a certain range near a fine pitch frequency, and perform a reciprocal operation on a frequency point corresponding to the peak, to obtain the fine pitch period.

The pitch detection apparatus further includes:

a pre-processing module, configured to perform pre-processing on the speech signal; and

a windowing module, configured to apply an analysis window to a pre-processed frame signal.

The time frequency conversion module, as shown in FIG. 12, further includes:

a frequency spectrum coefficient obtaining module, configured to perform frequency domain transform on the speech signal to which the analysis window has been applied, to obtain a frequency spectrum coefficient; and

an energy spectrum obtaining module, configured to calculate an energy spectrum according to the frequency spectrum coefficient.

The pitch detection apparatus further includes:

an energy spectrum smoothing module, configured to perform weighting processing on the energy spectrum according to a current frame and a previous frame to smooth the energy spectrum.

The pitch detection apparatus further includes:

a magnitude spectrum obtaining module, configured to calculate the magnitude spectrum of the frequency spectrum according to the energy spectrum.

The pitch detection apparatus further includes:

a magnitude spectrum interpolation module, configured to perform interpolation on the magnitude spectrum of the frequency spectrum to obtain a high-density magnitude spectrum of the speech signal.

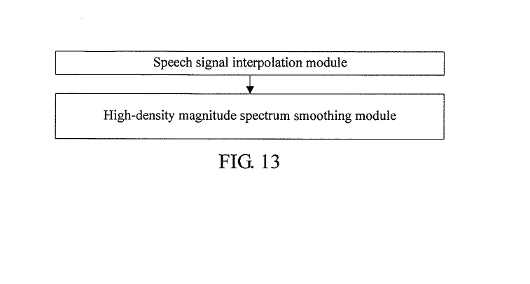

The time frequency conversion module, as shown in FIG. 13, further includes:

a speech signal interpolation module, configured to, after zero padding interpolation is performed on the tail of the speech signal, convert a speech signal to a frequency domain, to obtain a high-density magnitude spectrum of the speech signal.

The pitch detection apparatus further includes:

a high-density magnitude spectrum smoothing module, configured to perform weighting processing on the high-density magnitude spectrum according to the current frame and the previous frame to smooth the high-density magnitude spectrum.

For the pitch detection method and apparatus provided in the embodiments of the present invention, by performing detection on a pitch period according to an initial pitch period obtained in a time domain and a feature parameter extracted in a frequency domain, the occurrence of a multiple pitch error is avoided and the precision of pitch period detection is improved.

The foregoing descriptions are merely specific embodiments of the present invention, but are not intended to limit the protection scope of the present invention. Any variation or replacement readily figured out by persons skilled in the art within the technical scope disclosed in the present invention shall fall within the protection scope of the present invention. Therefore, the protection scope of the present invention shall be subject to the protection scope of the claims.

What is claimed is:

1. A pitch detection method, comprising:
performing pitch detection on a speech signal in a time domain to obtain an initial pitch period;
converting the speech signal to a frequency domain to obtain a frequency spectrum of the speech signal, wherein the frequency spectrum comprises a magnitude spectrum of the frequency spectrum;
extracting a feature parameter according to the initial pitch period and the frequency spectrum of the speech signal; and
performing fine pitch period detection according to the initial pitch period and the feature parameter to obtain a fine pitch period.

2. The pitch detection method according to claim 1, wherein performing fine pitch period detection according to the initial pitch period and the feature parameter to obtain a fine pitch period further comprises: performing determination according to a ratio parameter value of an average magnitude and a frequency point magnitude and an average magnitude parameter value, or performing determination according to a ratio parameter value of an average magnitude and a frequency point magnitude and a determination result of a multiple pitch frequency before a current frame stored in a cache.

3. The pitch detection method according to claim 2, wherein performing determination according to a ratio parameter value of an average magnitude and a frequency point magnitude and an average magnitude parameter value comprises:
determining whether a ratio of a ratio parameter value of a fundamental frequency point average magnitude and the frequency point magnitude to a ratio parameter value of a triple pitch frequency point average magnitude and the frequency point magnitude is greater than a first default value;
if the ratio of the ratio parameter value of the fundamental frequency point average magnitude and the frequency point magnitude to the ratio parameter value of the triple pitch frequency point average magnitude and the frequency point magnitude is greater than the first default value, determining whether a ratio of a ratio parameter value of a double pitch frequency point average magnitude and the frequency point magnitude to the ratio parameter value of the triple pitch frequency point average magnitude and the frequency point magnitude is greater than a second default value;
if the ratio of the ratio parameter value of the double pitch frequency point average magnitude and the frequency point magnitude to the ratio parameter value of the triple pitch frequency point average magnitude and the frequency point magnitude is greater than the second default value, determining whether a difference between a parameter value of the triple pitch frequency point average magnitude and a parameter value of the fundamental frequency point average magnitude is greater than a third default value; and
if the difference between the parameter value of the triple pitch frequency point average magnitude and the parameter value of the fundamental frequency point average magnitude is greater than the third default value, determining that a triple pitch frequency is a needed fine pitch frequency.

4. The pitch detection method according to claim 2, wherein performing determination according to a ratio parameter value of an average magnitude and a frequency point magnitude and a determination result of a multiple pitch frequency before a current frame stored in a cache comprises:
determining whether a ratio of a ratio parameter value of a fundamental frequency point average magnitude and the frequency point magnitude to a ratio parameter value of a triple pitch frequency point average magnitude and the frequency point magnitude is greater than a fourth default value;
if the ratio of the ratio parameter value of the fundamental frequency point average magnitude and the frequency point magnitude to the ratio parameter value of the triple pitch frequency point average magnitude and the frequency point magnitude is greater than the fourth default value, determining whether a ratio of a ratio parameter value of a double pitch frequency point average magnitude and the frequency point magnitude to the ratio parameter value of the triple pitch frequency point average magnitude and the frequency point magnitude is greater than a fifth default value;
if the ratio of the ratio parameter value of the double pitch frequency point average magnitude and the frequency point magnitude to the ratio parameter value of the triple pitch frequency point average magnitude and the frequency point magnitude is greater than the fifth default value, determining whether a triple pitch error occurs in a previous frame;
if the triple pitch error occurs in the previous frame, determining whether the number of times when the triple pitch error occurs before the current frame is greater than a sixth default value; and
if the number of times when the triple pitch error occurs before the current frame is greater than the sixth default value, determining that a triple pitch frequency is a needed fine pitch period.

5. The pitch detection method according to claim 2, wherein performing determination according to a ratio parameter value of an average magnitude and a frequency point magnitude and an average magnitude parameter value further comprises:
determining whether a ratio of a ratio parameter value of a fundamental frequency point average magnitude and the frequency point magnitude to a ratio parameter value of a double pitch frequency point average magnitude and the frequency point magnitude is greater than a seventh default value;
if the ratio of the ratio parameter value of the fundamental frequency point average magnitude and the frequency point magnitude to the ratio parameter value of the double pitch frequency point average magnitude and the frequency point magnitude is greater than the seventh default value, determining whether a ratio of a ratio parameter value of a triple pitch frequency point average magnitude and the frequency point magnitude to the ratio parameter value of the double pitch frequency point average magnitude and the frequency point magnitude is greater than an eighth default value;
if the ratio of the ratio parameter value of the triple pitch frequency point average magnitude and the frequency point magnitude to the ratio parameter value of the double pitch frequency point average magnitude and the frequency point magnitude is greater than the eighth default value, determining whether a difference between a parameter value of the double pitch frequency point average magnitude and a parameter value of the fundamental frequency point average magnitude is greater than a ninth default value; and
if the difference between the parameter value of the double pitch frequency point average magnitude and the parameter value of the fundamental frequency point average magnitude is greater than the ninth default value, determining that a double pitch frequency is a needed fine pitch frequency.

6. The pitch detection method according to claim 2, wherein the performing determination according to a ratio parameter value of an average magnitude and a frequency point magnitude and a determination result of a multiple pitch frequency before a current frame stored in a cache further comprises:
determining whether a ratio of a ratio parameter value of a fundamental frequency point average magnitude and the frequency point magnitude to a ratio parameter value of a double pitch frequency point average magnitude and the frequency point magnitude is greater than a tenth default value;
if the ratio of the ratio parameter value of the fundamental frequency point average magnitude and the frequency point magnitude to the ratio parameter value of the double pitch frequency point average magnitude and the frequency point magnitude is greater than the tenth default value, determining whether a ratio of a ratio parameter value of a triple pitch frequency point average magnitude and the frequency point magnitude to the ratio parameter value of the double pitch frequency point average magnitude and the frequency point magnitude is greater than an eleventh default value;
if the ratio of the ratio parameter value of the triple pitch frequency point average magnitude and the frequency point magnitude to the ratio parameter value of the double pitch frequency point average magnitude and the frequency point magnitude is greater than the eleventh default value, determining whether a double pitch error occurs in a previous frame;
if the double pitch error occurs in the previous frame, determining whether the number of times when the double pitch error occurs before the current frame is greater than a twelfth default value; and
if the number of times when the double pitch error occurs before the current frame is greater than the twelfth default value, determining that a double pitch frequency is a fine pitch frequency that needs to be detected.

7. The pitch detection method according to claim 1, wherein before extracting a feature parameter according to the initial pitch period and the frequency spectrum of the speech signal, the method comprises:
performing interpolation on the magnitude spectrum of the frequency spectrum to obtain a high-density magnitude spectrum of the speech signal.

8. The pitch detection method according to claim 7, wherein the interpolation comprises: cubic B-spline interpolation,
$$f ( x ) = {\sum }_{k ∈ Z}^{ } c ( k ) {β}^{3} ( x - k ) ,$$
wherein ƒ(x) is a signal to be interpolated, c(k) is a coefficient of triple B-spline interpolation, and β³(x) is a cubic B-spline base function.

9. The pitch detection method according to claim 8, wherein before the cubic B-spline interpolation, the method further comprises:
inserting L extension points at front and rear endpoints of the magnitude spectrum each, wherein values of the extension points are equal to values of the front and rear endpoints respectively.

10. The pitch detection method according to claim 1, wherein converting the speech signal to a frequency domain to obtain a frequency spectrum of the speech signal, wherein the frequency spectrum comprises a magnitude spectrum of the frequency spectrum, further comprises:
after zero padding is performed on the tail of the speech signal, converting the speech signal to the frequency domain, to obtain a high-density magnitude spectrum of the speech signal.

11. The pitch detection method according to claim 7, wherein after the high-density magnitude spectrum of the speech signal is obtained, the method comprises:
performing weighting processing on the high-density magnitude spectrum according to a current frame and a previous frame to smooth the high-density magnitude spectrum.

12. The pitch detection method according to claim 11, wherein performing fine pitch period detection according to the initial pitch period and the feature parameter to obtain a fine pitch period further comprises:
in the high-density magnitude spectrum, comparing magnitude values in certain ranges near a fundamental frequency point and multiple pitch frequency points, and determining peak positions in the certain ranges near the fundamental frequency point and the multiple pitch frequency points;
determining whether a frequency point exists among the fundamental frequency point and the multiple pitch frequency points, wherein a ratio of a ratio parameter value of an average magnitude and a frequency point magnitude of the frequency point to a ratio parameter value of an average magnitude and a frequency point magnitude of each of other frequency points is greater than a thirteenth default value, wherein the frequency point is referred to as a target frequency point;
if a frequency point exists among the fundamental frequency point and the multiple pitch frequency points, wherein the ratio of the ratio parameter value of the average magnitude and frequency point magnitude of the frequency point to the ratio parameter value of the average magnitude and frequency point magnitude of each of the other frequency points is greater than the thirteenth default value, determining whether a distance from the target frequency point to a peak position corresponding to the target frequency point is smaller than distances from the other frequency points to peak positions corresponding to the other frequency points; and
if the distance from the target frequency point to the peak position corresponding to the target frequency point is smaller than the distances from the other frequency points to the peak positions corresponding to the other frequency points, determining that a period corresponding to the target frequency point is a fine pitch period.

13. The pitch detection method according to claim 1, wherein before the converting the speech signal to a frequency domain to obtain a frequency spectrum of the speech signal, comprises:
performing pre-processing on the speech signal; and
applying an analysis window to a pre-processed frame signal.

14. The pitch detection method according to claim 13, wherein converting the speech signal to a frequency domain comprises:
performing frequency domain transform on the speech signal to which the analysis window has been applied, to obtain a frequency spectrum coefficient; and
calculating an energy spectrum according to the frequency spectrum coefficient.

15. The pitch detection method according to claim 14, wherein before calculating a magnitude spectrum according to the energy spectrum, the method comprises:
performing weighting processing on the energy spectrum according to a current frame and a previous frame to smooth the energy spectrum.

16. The pitch detection method according to claim 15, wherein after performing smoothing processing on the energy spectrum to obtain a smooth energy spectrum, the method comprises:
according to the energy spectrum, calculating the magnitude spectrum of the frequency spectrum.
S(k)=η+θ log₁₀(\sqrt{ε+E(k)}), k=0, . . . , K−1, wherein S(k) is a function of the magnitude spectrum.

17. A pitch detection apparatus, comprising:
an initial pitch period obtaining module, configured to perform pitch detection on a speech signal in a time domain to obtain an initial pitch period;
a time frequency conversion module, configured to convert the speech signal to a frequency domain to obtain a frequency spectrum of the speech signal, wherein the frequency spectrum comprises a magnitude spectrum of the frequency spectrum;
a feature parameter extraction module, configured to extract a feature parameter according to the initial pitch period and the frequency spectrum of the speech signal; and
a fine pitch period obtaining module, configured to perform fine pitch period detection according to the initial pitch period and the feature parameter to obtain a fine pitch period.

18. The pitch detection apparatus according to claim 17, wherein the fine pitch period obtaining module further comprises:
a multiple pitch frequency detection module, configured to compare feature parameters of a fundamental frequency point and a multiple pitch frequency point, determine a fine pitch frequency, and perform a reciprocal operation on the fine pitch frequency to obtain the fine pitch period.

19. The pitch detection apparatus according to claim 17, wherein the multiple pitch frequency detection module further comprises:
a peak search module, configured to search for a magnitude peak in a certain range near a fine pitch frequency, and perform a reciprocal operation on a frequency point corresponding to the peak, to obtain the fine pitch period.

20. The pitch detection apparatus according to claim 17, comprising:
a pre-processing module, configured to perform pre-processing on the speech signal; and
a windowing module, configured to apply an analysis window to a pre-processed frame signal.

21. The pitch detection apparatus according to claim 17, wherein the time frequency conversion module further comprises:
a frequency spectrum coefficient obtaining module, configured to perform frequency domain transform on the speech signal to which an analysis window has been applied, to obtain a frequency spectrum coefficient; and
an energy spectrum obtaining module, configured to calculate an energy spectrum according to the frequency spectrum coefficient.

22. The pitch detection apparatus according to claim 21, further comprising:
an energy spectrum smoothing module, configured to perform weighting processing on the energy spectrum according to a current frame and a previous frame to smooth the energy spectrum.

23. The pitch detection apparatus according to claim 22, further comprising:
a magnitude spectrum obtaining module, configured to calculate the magnitude spectrum of the frequency spectrum according to the energy spectrum.

24. The pitch detection apparatus according to claim 23, further comprising:
a magnitude spectrum interpolation module, configured to perform interpolation on the magnitude spectrum of the frequency spectrum to obtain a high-density magnitude spectrum of the speech signal.

25. The pitch detection apparatus according to claim 17, wherein the time frequency conversion module further comprises:
a speech signal interpolation module, configured to, after zero padding interpolation is performed on the tail of the speech signal, convert the speech signal to the frequency domain, to obtain a high-density magnitude spectrum of the speech signal.

26. The pitch detection apparatus according to claim 24, further comprising:
a high-density magnitude spectrum smoothing module, configured to perform weighting processing on the high-density magnitude spectrum according to a current frame and a previous frame to smooth the high-density magnitude spectrum.
